(19) United States
(12) Patent Application Publication
(10) Pub. No.: US 2003/0034635 A1
(43) Pub. Date: Feb. 20, 2003

(54) Wheelchair with a quick release assembly to vary a camber angle of the wheels

(76) Inventor: Alan Ludovici, Kennewick, WA (US)

Correspondence Address: IRELL & MANELLA LLP, 840 NEWPORT CENTER DRIVE, SUITE 400, NEWPORT BEACH, CA, 92660, US

(21) Appl. No.: 09/933,990

(22) Filed: Aug. 20, 2001

(51) Int. Cl. B62B 3/00; B62B 5/00

(52) U.S. Cl. 280/647; 280/304.1

(57) ABSTRACT

A wheelchair that includes a number of quick release assemblies which allow a user to readily vary the wheel camber angles. The quick release assemblies can be locked and unlocked without any tools, thereby allowing the user to vary the camber angles at any time or location. Additionally, the quick release assemblies extend through a number of apertures that provide discrete angle positions that readily allow a user to quickly select one of a variety of camber angles.

### BACKGROUND OF THE INVENTION

1. Field of the Invention

The present invention relates to a wheelchair that can be adjusted to vary the camber angle of the wheels.

2. Background Information

Wheelchairs typically have a pair of large rear wheels and a pair of smaller front wheels that are coupled to a frame. Some wheelchairs allow the user to adjust the camber angle of the rear wheels. For example, U.S. Pat. No. 5,884,928 issued to Papac, discloses a wheelchair that allows the user to adjust the wheel camber between 0,3,6,9 and 12 degrees. The frame of the Papac wheelchair includes a plate with a plurality of holes. The wheel axles are attached to the frame plate with bolts that extend through the holes of the plate. The camber angle can be varied by attaching the wheel axles to the frame at different hole locations. This is a time consuming process that requires the use of tools which may not be available to the user. Additionally, attaching the axles at different hole locations may vary the height of the seat and wheels. Other parts of the wheelchair must also be adjusted to maintain user comfort, further complicating the process of adjusting the chair.

U.S. Pat. No. 5,259,635 issued to Picker discloses a wheelchair that allows the user to adjust the wheel camber. The frame is constructed to allow camber adjustment without varying the height of the wheel. Like Papac, the axles of the Picker wheelchair are attached to a frame with nuts and bolts. Picker provides slots in the frame to allow adjustment of the wheel cambers. The user must accurately slide the axles along the slots so that each wheel has the same camber. Accurately aligning the wheel axles within the slots of the frame may be a time consuming process. Additionally, the nuts and bolts require tools that may not be accessible to the user.

### BRIEF SUMMARY OF THE INVENTION

One embodiment of the present invention is a wheelchair that includes a quick release assembly which can couple a wheel axle to a frame. The quick release assembly extends through one of a plurality of apertures in the frame. The quick release assembly allows a user to vary the wheel camber of the wheelchair.

### BRIEF DESCRIPTION OF THE DRAWINGS

FIG. 1 is a front perspective view of a wheelchair of the present invention;

FIG. 2 is an enlarged perspective view of the wheelchair frame;

FIG. 3 is a cross-sectional view showing a quick release assembly of the wheelchair.

### DETAILED DESCRIPTION OF THE PREFERRED EMBODIMENT

Disclosed is a wheelchair that has a number of quick release assemblies which allow a user to readily vary the wheel camber angles. The quick release assemblies can be locked and unlocked without any tools, thereby allowing the user to vary the camber angles at any time or location. Additionally, the quick release assemblies extend through a number of apertures that provide discrete angle positions that readily allow a user to quickly select one of a variety of camber angles.

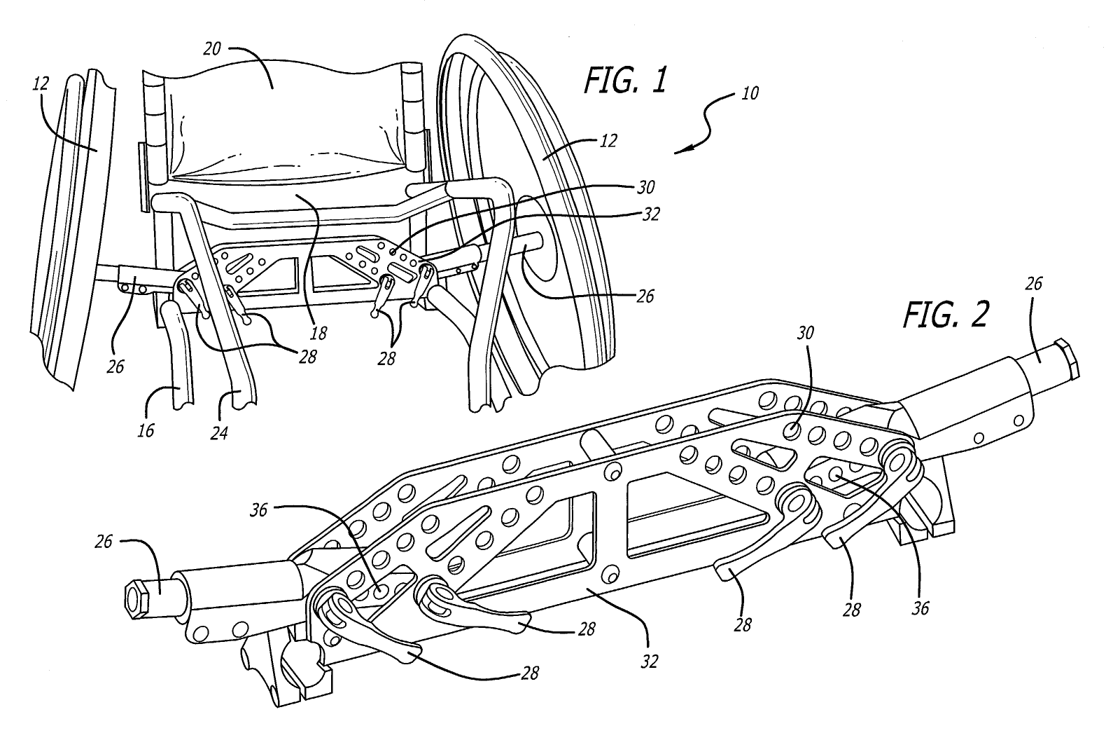

Referring to the drawings more particularly by reference numbers, FIG. 1 shows an embodiment of a wheelchair 10 of the present invention. The wheelchair 10 has a pair of rear wheels 12 and a pair of front wheels (not shown) that are attached to a frame 16. The frame 16 may also support a seat 18, a back 20 and a toe rest (not shown) suitable to support a user. The seat 18 and back 20 may include a cloth material that is attached to bent tubes 24 of the frame 16. The front wheels typically have caster bearings to allow the wheels 14 to rotate 360 degrees relative to the frame 16.

Each rear wheel 12 may be connected to an axle 26 that is coupled to the frame 16 by a pair of quick release assemblies 28. The quick release assemblies 28 extend through apertures 30 of a camber adjustment bracket 32 of the frame 16. The frame apertures 30 may be arranged in four rows, each row containing five apertures 30. The apertures 30 are located at portions of the frame plate 32 such that the wheel height, or any other portion of the wheelchair 10, does not vary when the user adjust the camber angle of the wheels 12. The apertures 30 may allow the user to select between camber angles of 0, 3, 6, 9 and 12 degrees.

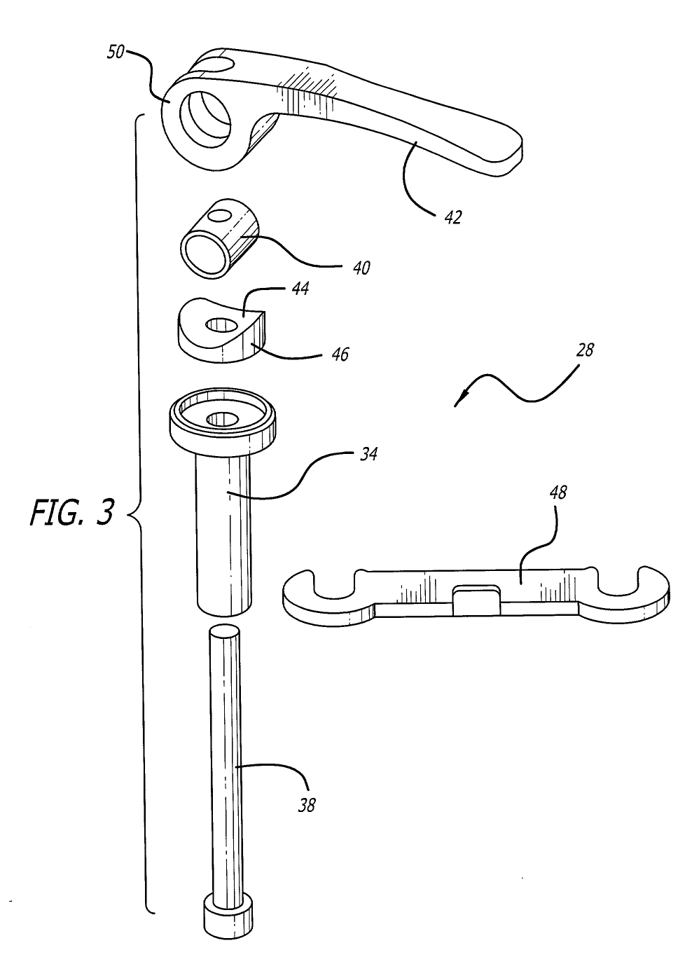

As shown in FIGS. 2 and 3, each quick release assembly 28 includes an outer sleeve 34 that extends through an aperture 36 in the wheel axle 26 and a pair of aligned apertures 30 in the frame plate 32. The assembly 28 further includes a bolt 38 that extends through the sleeve 34 and is attached to a pivot 40 located within a handle 42. The handle 42 can rotate within a groove 44 of a washer 46 that is seated within the sleeve 34. The assembly 28 further includes a retainer plate 48 that is coupled to the bolt 36. The retainer plate 48 may be configured to capture a pair of bolts. The assembly handle 42 has an over-center opening 48 that creates a cam effect when the handle 40 is rotated. When rotated inward the handle 40 pulls the bolt 36 toward the frame 16 to lock the quick release assembly 28 and secure the wheel axle 26. When rotated outward the handle moves the bolt away from the frame to unlock the release assembly 28.

In operation, to vary the wheel camber the user can unlock the quick release assemblies 28 by rotating the handles 42 in an outward direction. The user can then pull out a pair of release assemblies 28, move the wheel axle 26 so that the axle apertures 36 align with a different set of apertures 30 in the frame bracket 32. The user can then insert the quick release assemblies 28 through the aligned apertures 30 and 36, and rotate the handles 42 to lock the assemblies 28. The user does not have to use any tools to vary the wheel camber angles. Additionally, the discrete apertures 30 allow the user to easily select and synchronize the camber angle of each wheel, unlike wheelchairs of the prior art which have slots.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A wheelchair, comprising:
a frame that has a plurality of apertures;
an axle that has an aperture and is coupled to said frame;
a wheel that is coupled to said axle;
a seat attached to said frame;
a quick release assembly that extends through said axle aperture one of said frame apertures.

2. The wheelchair of claim 1, wherein said apertures of said frame are arranged so that a camber of said wheel can be varied without significantly changing a height of said wheel.

3. The wheelchair of claim 1, wherein said quick release assembly includes a handle that can be rotated to lock or unlock said quick release assembly to said frame.

4. The wheelchair of claim 3, wherein said quick release assembly includes a bolt that is coupled to said handle and a retainer plate that couples said bolt to said frame.

5. The wheelchair of claim 1, wherein said apertures allow said wheel to be varied to five different camber angles.

6. A wheelchair, comprising:
a frame that has a plurality of apertures;
an axle that has an aperture and is coupled to said frame;
a wheel that is coupled to said axle;
a seat attached to said frame;
quick release means for coupling said axle to said frame through at least one of said frame apertures.

7. The wheelchair of claim 6, wherein said apertures of said frame are arranged so that a camber of said wheel can be varied without significantly changing a height of said wheel.

8. The wheelchair of claim 6, wherein said quick release means includes a handle that can be rotated to lock or unlock said quick release means to said frame.

9. The wheelchair of claim 8, wherein said quick release means includes a bolt that is coupled to said handle and a retainer plate that couples said bolt to said frame.

10. The wheelchair of claim 1, wherein said apertures allow said wheel to be varied to five different camber angles.

11. A method for adjusting a camber angle of a wheel of a wheelchair, comprising:
unlocking a quick release assembly;
pulling the quick release assembly out of a first aperture of a frame and an aperture of an axle coupled to the frame;
moving an axle that is attached to a wheel to vary a camber angle of the wheel;
inserting the quick release assembly through the axle aperture and a second aperture in the frame; and,
locking the quick release assembly.

12. The method of claim 11, wherein the quick release assembly is locked and unlocked by rotating a handle.

13. The method of claim 11, wherein the camber angle can be varied to one of five values.
